(19) United States
(12) Patent Application Publication
(10) Pub. No.: US 2026/0213611 A1
(43) Pub. Date: Jul. 23, 2026

(54) ACTUATOR

(71) Applicant: DENSO CORPORATION, Kariya-city (JP)

(72) Inventors: Kandai NAGATA, Kariya-city (JP); Naoto NATSUME, Kariya-city (JP); Yuji TAKEMURA, Kariya-city (JP); Masayuki TAKAHASHI, Kariya-city (JP)

(73) Assignee: DENSO CORPORATION, Kariya-city (JP)

(21) Appl. No.: 19/567,791

(22) Filed: Mar. 16, 2026

Related U.S. Application Data
(63) Continuation of application No. PCT/JP2024/025019, filed on Jul. 10, 2024.

(30) Foreign Application Priority Data
Sep. 15, 2023 (JP) 2023-150589

(51) Int. Cl. H02K 7/00; H02K 1/12

(52) U.S. Cl. CPC H02K 7/003; H02K 1/12

(57) ABSTRACT

An actuator includes a stator formed in a ring shape and configured to generate a rotating magnetic field. Moreover, the actuator also includes a shaft formed of a soft-magnetic material, arranged radially inside the stator and having a magnet mounted thereto. The shaft is configured to rotate under the rotating magnetic field generated by the stator. Furthermore, the actuator also includes a linear motion part provided in a rotation center part of the shaft and configured to be displaced in an axial direction with rotation of the shaft.

### CROSS-REFERENCE TO RELATED APPLICATIONS

The present application is a continuation application of International Application No. PCT/JP2024/025019 filed on July 10, 2024, which is based on and claims priority from Japanese Patent Application No. 2023-150589 filed on September 15, 2023. The entire contents of these applications are incorporated by reference into the present application.

### BACKGROUND

### 1 Technical Field

The present disclosure relates to actuators.

### 2 Description of Related Art

There is disclosed, for example in Japanese Patent No. JP 7225353 B2, a disconnector apparatus that is provided in a vehicle and configured to switch the vehicle between a state in which the vehicle can travel in a two-wheel drive mode and a state in which the vehicle can travel in a four-wheel drive mode. Specifically, the disconnector apparatus separates or connects a differential shaft and a hub according to driving conditions, thereby switching the vehicle between the state in which the vehicle can travel in the two-wheel drive mode and the state in which the vehicle can travel in the four-wheel drive mode. More specifically, the disconnector apparatus includes: a ball screw shaft that rotates by the operation of a motor; a nut coupled to the ball screw shaft; a sleeve that moves together with the nut; and a fork engaged with the sleeve. With rotation of the ball screw shaft by the operation of the motor, the nut moves the fork via the sleeve, thereby connecting the differential shaft and the hub or releasing the connection between the differential shaft and the hub.

### SUMMARY

In terms of the mountability of the disconnector apparatus to the vehicle, it is desirable to shorten the axial distance from a rotating part such as the motor to an axial displacement part such as the nut. In this regard, there is room for improvement in the configuration of the disconnector apparatus disclosed in the aforementioned patent document.

The present disclosure has been accomplished in view of the above circumstances.

According to the present disclosure, there is provided an actuator which includes: a stator formed in a ring shape and configured to generate a rotating magnetic field; a shaft formed of a soft-magnetic material, arranged radially inside the stator and having a magnet mounted thereto, the shaft being configured to rotate under the rotating magnetic field generated by the stator; and an axial displacement part provided in a rotation center part of the shaft and configured to be displaced in an axial direction with rotation of the shaft.

With the above configuration, it becomes possible to achieve reduction in the axial distance from a rotating part to an axial displacement part.

### BRIEF DESCRIPTION OF THE DRAWINGS

FIG. 1 is a cross-sectional view showing a cross-section, taken along an axial direction, of an actuator according to a first embodiment.

FIG. 2 is a front view showing part of the actuator where a fork and a main shaft engage with each other.

FIG. 3 is a cross-sectional view showing a cross-section, taken along an axial direction, of an actuator according to a second embodiment.

FIG. 4 is a cross-sectional view showing a cross-section, taken along an axial direction, of an actuator according to a third embodiment.

FIG. 5 is a cross-sectional view showing a cross-section, taken along an axial direction, of an actuator according to a fourth embodiment.

### DESCRIPTION OF EMBODIMENTS

### First Embodiment

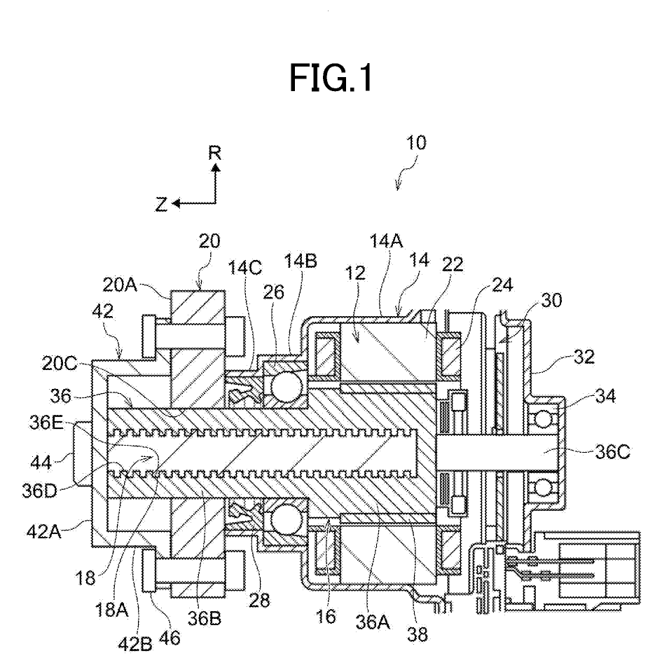

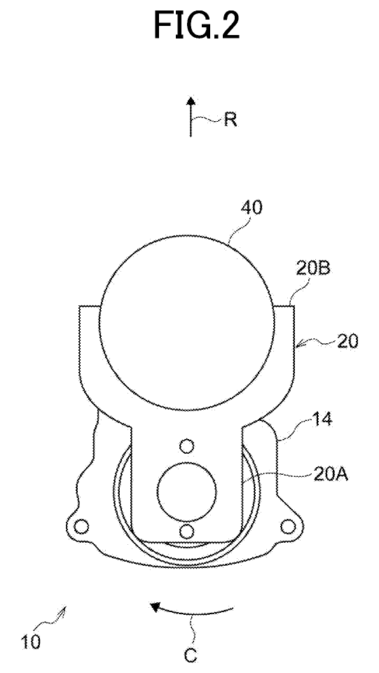

An actuator 10 according to a first embodiment of the present disclosure will be described with reference to FIGS. 1 and 2. It should be noted that the arrows Z, R and C suitably shown in the drawings respectively indicate a first side in a rotation axial direction, the outer side in a rotation radial direction and a first side in a rotation circumferential direction of a rotor 16 that will be described later. Moreover, in the case of merely indicating the axial direction, the radial direction and the circumferential direction, unless specified otherwise, the arrows Z, R and C respectively indicate the rotation axial direction, the rotation radial direction and the rotation circumferential direction of the rotor 16.

As shown in FIG. 1, the actuator 10 according to the present embodiment includes a stator 12 that generates a rotating magnetic field, and a housing 14 that accommodates the stator 12 and other components. Moreover, the actuator 10 also includes a rotor 16 that rotates under the rotating magnetic field generated by the stator 12, and a linear motion part 18 serving as an axial displacement part that is displaced in the axial direction with rotation of the rotor 16. Furthermore, the actuator 10 also includes a fork 20 serving as a transmission part connected with the linear motion part 18.

The stator 12 includes a stator core 22 formed in a ring shape and a plurality of coils 24 wound around the stator core 22. The rotating magnetic field is generated around the stator 12 by switching energization of the plurality of coils 24. The stator 12 is supported by the housing 14, which will be described later, by, for example, press-fitting the stator core 22 into the housing 14.

The housing 14 is formed in a hollow cylindrical shape extending in the axial direction. The housing 14 has a stator support portion 14A that supports the stator 12 located on the radially inner side thereof. Moreover, the housing 14 also has a bearing support portion 14B that supports a bearing 26 located on the radially inner side thereof. The bearing support portion 14B is located adjacent to the stator support portion 14A on the first axial side of the stator support portion 14A, and has a smaller diameter than the stator support portion 14A. Furthermore, the housing 14 also has an oil-seal support portion 14C that supports an oil seal 28 located on the radially inner side thereof. The oil-seal support portion 14C is arranged adjacent to the bearing support portion 14B on the first axial side of the bearing support portion 14B, and has a smaller diameter than the bearing support portion 14B. On the second axial side of the housing 14, there are arranged a control unit 30, which controls the supply of electric current to the stator 12 (more specifically, to the plurality of coils 24), and a housing cover 32. The housing 14 is closed on the second axial side thereof by the control unit 30 and the housing cover 32. Moreover, a bearing 34 is fixed to the housing cover 32.

The rotor 16 includes a shaft 36 formed of a soft-magnetic material such as steel, and a magnet 38 mounted to the shaft 36. The shaft 36 has a large-diameter portion 36A that is located radially inside the stator 12. Moreover, the shaft 36 also has a medium-diameter portion 36B that protrudes from the large-diameter portion 36A toward the first side in the axial direction and has an outer diameter smaller than that of the large-diameter portion 36A. Furthermore, the shaft 36 also has a small- diameter portion 36C that protrudes from the large-diameter portion 36A toward the second side in the axial direction and has an outer diameter smaller than that of the medium-diameter portion 36B. A part of the medium-diameter portion 36B, which adjoins the large-diameter portion 36A, is supported by the bearing 26; and an end part of the small-diameter portion 36C on the second side in the axial direction is supported by the bearing 34. Consequently, it becomes possible for the shaft 36 to rotate with the bearings 26 and 34 serving as the shaft support parts. The magnet 38 is fixed to a radially outer surface of the large-diameter portion 36A. It should be noted that the magnet 38 may be implemented by a segmented magnet that is segmented in the circumferential direction, or by a ring magnet that is formed in a ring shape. It also should be noted that the magnet 38 may alternatively be provided on an inner periphery of the large-diameter portion 36A. A linear-motion-part insertion hole 36D, into which the linear motion part 18 (to be described later) is inserted from the first side in the axial direction, is formed in rotation center parts of the large-diameter portion 36A and the medium-diameter portion 36B. An end of the linear-motion-part insertion hole 36D on the first side in the axial direction is open toward the first side in the axial direction on an end surface of the medium-diameter portion 36B on the first side in the axial direction. On the other hand, an end of the linear-motion-part insertion hole 36D on the second side in the axial direction is closed in the large-diameter portion 36A. Moreover, on an inner peripheral surface of the linear-motion-part insertion hole 36D, there is formed a first threaded portion 36E along the axial direction.

The linear motion part 18 is formed of a bar-shaped steel material. On an outer peripheral surface of the linear motion part 18, there is formed a second threaded portion 18A along the axial direction. The linear motion part 18 is inserted in the linear-motion-part insertion hole 36D of the shaft 36 with the second threaded portion 18A and the first threaded portion 36E meshed with each other. As shown in FIGS. 1 and 2, the fork 20 is arranged on a radially outer periphery of the medium-diameter portion 36B of the shaft 36. The fork 20 has a slidably-supported portion 20A that is slidably supported on the medium-diameter portion 36B of the shaft 36, and a main-shaft engagement portion 20B that protrudes radially outward from the slidably-supported portion 20A. In the slidably-supported portion 20A, there is formed a slide hole 20C in which the medium-diameter portion 36B of the shaft 36 is inserted. An inner peripheral surface of the slide hole 20C and an outer peripheral surface of the medium-diameter portion 36B slide against each other, allowing the fork 20 to be moved (or displaced) in the axial direction along the medium-diameter portion 36B of the shaft 36. Moreover, the main-shaft engagement portion 20B of the fork 20 is engaged with a main shaft 40 that constitutes a part of a mechanism; the mechanism is a control target of the actuator 10 according to the present embodiment. Consequently, mechanical power can be transmitted from the fork 20 to the control target.

The fork 20 is connected with the linear motion part 18 via a connection member 42. The connection member 42 has a first connection portion 42A that is fixed to an end of the linear motion part 18 on the first side in the axial direction via a fastening member 44. Moreover, the connection member 42 also has a second connection portion 42B that extends from a radially outer end of the first connection portion 42A toward the second side in the axial direction. An end of the second connection portion 42B on the second side in the axial direction is fixed to the fork 20 via fastening members 46. Consequently, the fork 20 can be moved in the axial direction together with the linear motion part 18 and the connection member 42.

Next, operation and effects of the actuator 10 according to the present embodiment will be described.

Referring to FIGS. 1 and 2, in the above-described actuator 10 according to the present embodiment, when a rotating magnetic field generated by the stator 12 causes the rotor 16 to rotate toward the first side in the circumferential direction, the shaft 36 rotates toward the first side in the circumferential direction relative to the linear motion part 18. The first threaded portion 36E of the shaft 36 and the second threaded portion 18A of the linear motion part 18 are meshed with each other. Therefore, with the rotation of the shaft 36 toward the first side in the circumferential direction relative to the linear motion part 18, the linear motion part 18 is moved (or displaced) toward the first side in the axial direction relative to the shaft 36. In contrast, when a rotating magnetic field generated by the stator 12 causes the rotor 16 to rotate toward the second side in the circumferential direction, the shaft 36 rotates toward the second side in the circumferential direction relative to the linear motion part 18, causing the linear motion part 18 to be moved toward the second side in the axial direction relative to the shaft 36. Moreover, in the actuator 10 according to the present embodiment, with the movement of the linear motion part 18 in the axial direction, the fork 20 can be moved in the axial direction along the main shaft 40. Consequently, it becomes possible to control the control target.

In the actuator 10 according to the present embodiment, the linear motion part 18 is inserted in a rotation center part of the shaft 36. With such a configuration, it becomes possible to shorten the axial length of a range from the shaft 36, which is a rotating part, to the linear motion part 18 in comparison with a configuration where the linear motion part 18 is arranged on an axial extension of the shaft 36.

In the present embodiment, the fork 20 is slidably supported on the medium- diameter portion 36B of the shaft 36. With such a configuration, it becomes unnecessary to provide, in the actuator 10, a part dedicated to supporting the fork 20. As a result, it becomes possible to prevent the number of parts of the actuator 10 from increasing and to prevent the configuration of the actuator 10 from becoming complicated.

In the present embodiment, the linear motion part 18 can be prevented, by the engagement of the fork 20 with the main shaft 40, from rotating in the circumferential direction. With such a configuration, it becomes unnecessary to provide, in the actuator 10, a part dedicated to preventing the linear motion part 18 from rotating in the circumferential direction. As a result, it becomes possible to prevent the number of parts of the actuator 10 from increasing and to prevent the configuration of the actuator 10 from becoming complicated.

In the present embodiment, the magnet 38 is provided on the large-diameter portion 36A of the shaft 36. Consequently, the large-diameter portion 36A of the shaft 36 functions as a rotor core of the rotor 16. With such a configuration, it becomes possible to suppress increase in the number of parts of the rotor 16 in comparison with a rotor configuration where a rotor core is fixed to a shaft.

In the present embodiment, the stator support portion 14A, the bearing support portion 14B and the oil-seal support portion 14C of the housing 14 are arranged adjacent to one another in the axial direction; thus, the stator 12, the bearing 26 and the oil seal 28 are also arranged adjacent to one another in the axial direction. Consequently, by arranging the stator 12, the bearing 26 and the oil seal 28 closely in the axial direction, it becomes possible to achieve reduction in the size of the actuator 10 in the axial direction.

### Second Embodiment

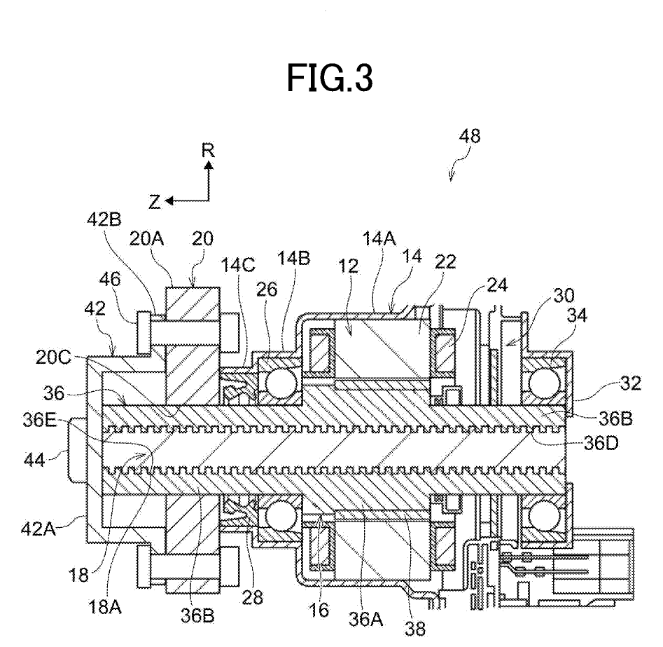

Next, an actuator 48 according to a second embodiment will be described with reference to FIG. 3. It should be noted that: members and parts of the actuator 48 according to the second embodiment corresponding to those of the actuator 10 according to the first embodiment are designated by the same reference signs as the corresponding members and parts of the actuator 10 according to the first embodiment; and description of these parts and members will be omitted hereinafter.

As shown in FIG. 3, in the actuator 48 according to the present embodiment, the shaft 36 has two medium-diameter portions 36B that protrude from the large- diameter portion 36A respectively toward the first side and the second side in the axial direction. The fork 20 is arranged on a radially outer periphery of that medium- diameter portion 36B of the shaft 36 which is located on the first side of the large- diameter portion 36A in the axial direction. The linear-motion-part insertion hole 36D, into which the linear motion part 18 is inserted, is formed in rotation center parts of the large-diameter portion 36A and the medium-diameter portions 36B. A first-axial-side end of the linear-motion-part insertion hole 36D is open toward the first side in the axial direction on a first-axial-side end surface of the first-axial-side medium-diameter portion 36B. On the other hand, a second-axial-side end of the linear-motion-part insertion hole 36D is open toward the second side in the axial direction on a second-axial-side end surface of the second-axial-side medium- diameter portion 36B. That is, the linear-motion-part insertion hole 36D penetrates a rotation center part of the shaft 36 in the axial direction.

In the above-described actuator 48 according to the present embodiment, it becomes possible to provide, in the rotation center part of the shaft 36, the linear motion part 18 which is longer than that of the actuator 10 according to the first embodiment. Consequently, in the actuator 48 according to the present embodiment, it becomes possible to expand the movement range of the linear motion part 18 and the fork 20 in the axial direction in comparison with that in the actuator 10 according to the first embodiment.

### Third Embodiment

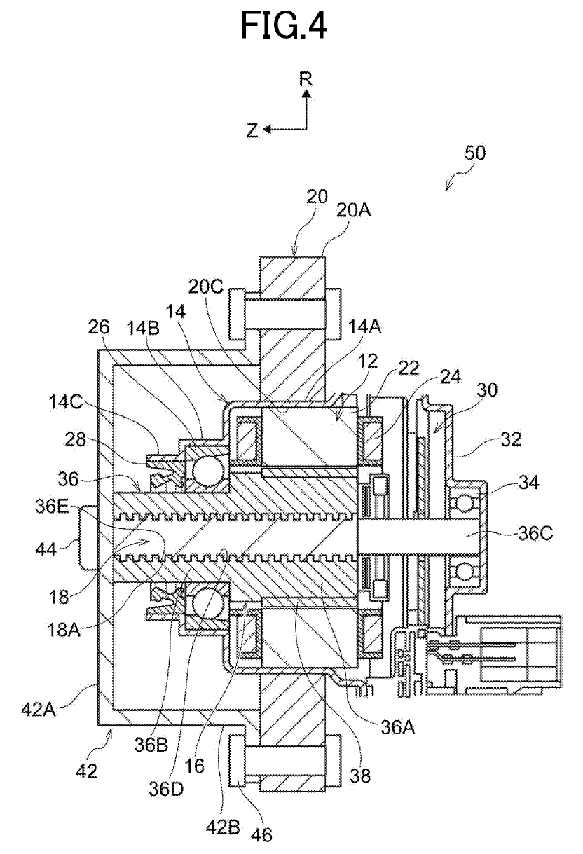

Next, an actuator 50 according to a third embodiment will be described with reference to FIG. 4. It should be noted that: members and parts of the actuator 50 according to the third embodiment corresponding to those of the actuator 10 according to the first embodiment are designated by the same reference signs as the corresponding members and parts of the actuator 10 according to the first embodiment; and description of these parts and members wilt be omitted hereinafter.

As shown in FIG. 4, in the actuator 50 according to the present embodiment, the fork 20 is arranged on the radially outer side of the stator support portion 14A of the housing 14 as well as on the radially outer side of the large-diameter portion 36A of the shaft 36. Moreover, the fork 20 is slidably supported on the stator support portion 14A of the housing 14. More specifically, the stator support portion 14A of the housing 14 is inserted in the slide hole 20C of the slidably-supported portion 20A of the fork 20. The inner peripheral surface of the slide hole 20C and an outer peripheral surface of the stator support portion 14A slide against each other, allowing the fork 20 to be moved (or displaced) in the axial direction along the stator support portion 14A of the housing 14.

In the above-described actuator 50 according to the present embodiment, the axial length of the medium-diameter portion 36B of the shaft 36 can be set to be shorter than that in the actuator 10 according to the first embodiment. Consequently, it becomes possible to make the size of the actuator 50 according to the present embodiment smaller than that of the actuator 10 according to the first embodiment in the axial direction.

### Fourth Embodiment

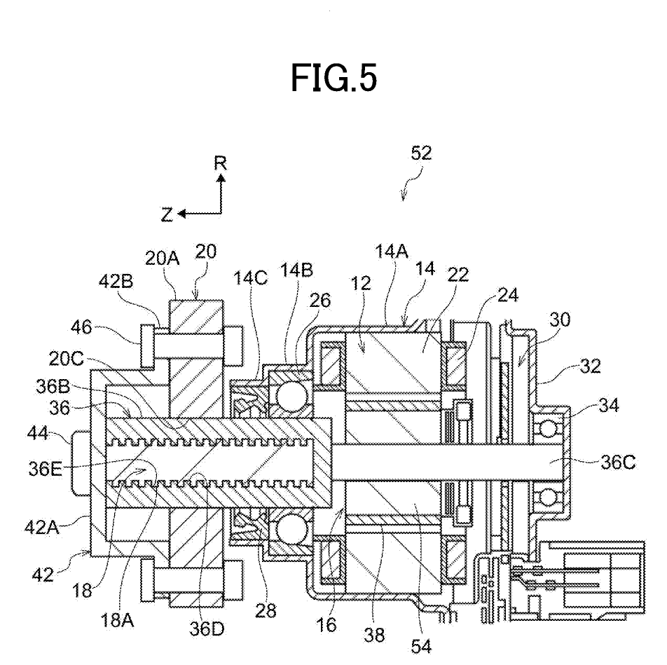

Next, an actuator 52 according to a fourth embodiment will be described with reference to FIG. 5. It should be noted that: members and parts of the actuator 52 according to the fourth embodiment corresponding to those of the actuator 10 according to the first embodiment are designated by the same reference signs as the corresponding members and parts of the actuator 10 according to the first embodiment; and description of these parts and members will be omitted hereinafter.

As shown in FIG. 5, in the actuator 52 according to the present embodiment, that part of the shaft 36 which corresponds to the large-diameter portion 36A of the shaft 36 in the actuator 10 according to the first embodiment is formed as a small- diameter portion 36C. A rotor core 54 is fixed to the small-diameter portion 36C by press fitting or the like. Moreover, a magnet 38 is fixed to an outer peripheral surface of the rotor core 54. The fork 20 is arranged on a radially outer periphery of the medium-diameter portion 36B of the shaft 36.

As described above, the actuator 52 according to the present embodiment is configured to include the rotor core 54. With such a configuration, the actuator 52 can be designed to employ a rotor core 54 of another motor as a part thereof.

In the actuators 10, 48, 50 and 52 according to the above-described embodiments, the fork 20 is moved in the axial direction by the linear motion part 18. However, the present disclosure is not limited to this configuration. For example, a configuration may alternatively be employed where a member different from the fork 20 is moved in the axial direction by the linear motion part 18. As another alternative, a configuration may be employed where the linear motion part 18 is directly engaged with the control target.

While exemplary embodiments of the present disclosure have been described as above, it should be appreciated that the present disclosure is not limited to the above-described embodiments, but can also be implemented through various modifications to the above-described embodiments without departing from the spirit of the present disclosure.

The following notes summarize the technical ideas derived from the present disclosure.

### Notes

### First Note

An actuator (10, 48, 50, 52) comprising:

a stator (12) formed in a ring shape and configured to generate a rotating

magnetic field;

a shaft (36) formed of a soft-magnetic material, arranged radially inside the

stator and having a magnet (38) mounted thereto, the shaft being configured to rotate

under the rotating magnetic field generated by the stator; and

an axial displacement part (18) provided in a rotation center part of the shaft

and configured to be displaced in an axial direction with rotation of the shaft.

### Second Note

The actuator according to the first note, wherein:

on a radially outer side of the shaft, there is provided a transmission part

(20) that is connected with the axial displacement part; and

the transmission part is configured to be displaced in the axial direction with the displacement of the axial displacement part in the axial direction.

### Third Note

The actuator according to the second note, wherein:

the transmission part is provided along an outer peripheral surface of the

shaft; and

the transmission part is configured to be displaced along the outer peripheral

surface of the shaft with the displacement of the axial displacement part in the axial

direction.

### Fourth Note

The actuator according to the second note, wherein:

the transmission part is provided radially outside the stator and along an

outer peripheral surface of a housing (14) that supports the stator; and

the transmission part is configured to be displaced along the outer peripheral

surface of the housing with the displacement of the axial displacement part in the

axial direction.

While the present disclosure has been described pursuant to the embodiments, it should be appreciated that the present disclosure is not limited to the embodiments and the structures. Instead, the present disclosure encompasses various modifications and changes within equivalent ranges. In addition, various combinations and modes are also included in the category and the scope of technical idea of the present disclosure.

What is claimed is:

1. An actuator comprising:
a stator formed in a ring shape and configured to generate a rotating magnetic field;
a shaft formed of a soft-magnetic material, arranged radially inside the stator and having a magnet mounted thereto, the shaft being configured to rotate under the rotating magnetic field generated by the stator; and
an axial displacement part provided in a rotation center part of the shaft and configured to be displaced in an axial direction with rotation of the shaft,
wherein:
on a radially outer side of the shaft, there is provided a transmission part, which is connected with the axial displacement part, along an outer peripheral
surface of the shaft, and
the transmission part is configured to be displaced, with the displacement of the axial displacement part in the axial direction, in the axial direction along the outer
peripheral surface of the shaft.

2. An actuator comprising:
a stator formed in a ring shape and configured to generate a rotating magnetic field;
a shaft formed of a soft-magnetic material, arranged radially inside the stator and having a magnet mounted thereto, the shaft being configured to rotate under the rotating magnetic field generated by the stator; and
an axial displacement part provided in a rotation center part of the shaft and configured to be displaced in an axial direction with rotation of the shaft,
wherein:
on a radially outer side of the shaft, there is provided a transmission part,
which is connected with the axial displacement part, along an outer peripheral surface of a housing that is arranged radially outside the stator and supports the
stator; and the transmission part is configured to be displaced, with the displacement of the axial displacement part in the axial direction, in the axial direction along the outer peripheral surface of the housing with an inner peripheral surface of the transmission part and the outer peripheral surface of the housing sliding against each other.
